(19) United States
(12) Patent Application Publication
(10) Pub. No.: US 2022/0318653 A1
(43) Pub. Date: Oct. 6, 2022

(54) SOCIAL MEDIA CONTENT RECOMMENDATION

(71) Applicant: FUJITSU LIMITED, Kawasaki-shi (JP)

(72) Inventors: Jun WANG, San Jose, CA (US); Kanji UCHINO, Santa Clara, CA (US)

(73) Assignee: FUJITSU LIMITED, Kawasaki-shi (JP)

(21) Appl. No.: 17/219,873

(22) Filed: Mar. 31, 2021

(51) Int. Cl. G06N 5/04; G06Q 50/00; G06N 5/02; G06N 20/00

(52) U.S. Cl. CPC G06N 5/04; G06Q 50/01; G06N 5/02; G06N 20/00

(57) ABSTRACT

Operations include obtaining a user graph of users of a social network, obtaining a content graph that indicates links between the users and content items interacted with by the users, and obtaining a resource graph that indicates links between the content items and external resources. The operations include generating first user representations, first content representations, and first resource representations. The operations include generating second resource representations based on the first content representations, the first resource representations, and the resource graph; generating second content representations based on the first content representations, the first user representations, the content graph, and the second resource representations; and generating second user representations based on the first user representations, the user graph, the first content representations, and the content graph. The operations include generating a user-content relation classifier of a machine learning network based on combinations of the second content representations and the second user representations.

### FIELD

The embodiments discussed in the present disclosure are related to social media content recommendation.

### BACKGROUND

With the advent of computer networks, such as the Internet, and the growth of technology, more and more information is available to more and more people. For example, social media is often used as a source of domain-specific knowledge.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to one or more embodiments, operations may include obtaining a user graph that indicates links between users of a social network, obtaining a content graph that indicates links between the users of the social network and content items interacted with by the users via the social network, and obtaining a resource graph that indicates links between the content items and external resources included in the content items. In addition, the operations may include generating first user representations of the users of the social network, generating first content representations of the content items, and generating first resource representations of the external resources. Moreover, the operations may include generating second resource representations of the external resources based on the first content representations, the first resource representations, and the resource graph; generating second content representations of the content items based on the first content representations, the first user representations, the content graph, and the second resource representations; and generating second user representations of the users based on the first user representations, the user graph, the first content representations, and the content graph. In addition, the operations may include generating a user-content relation classifier of a machine learning network based on combinations of the second content representations and the second user representations.

The objects and advantages of the embodiments will be realized and achieved at least by the elements, features, and combinations particularly pointed out in the claims. Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A is a diagram of an example environment related to providing content recommendations;

FIG. 1B illustrates an example user graph, an example content graph, and an example resource graph;

FIG. 2 illustrates a block diagram of an example computing system;

FIG. 3 illustrates an example flow of operations configured to generate a user-content classifier;

FIG. 4 illustrates an example flow of operations configured to generate an updated resource vector;

FIG. 5 illustrates an example flow of operations configured to generate an updated content vector and

FIG. 6 illustrates an example flow of operations configured to generate an updated user vector;

FIG. 7 illustrates an example flow of operations configured to generate another updated user vector;

FIG. 8 is a flowchart of an example method of obtaining a content recommendation; and

FIG. 9 is a flowchart of an example method of generating a user-content classifier.

### DESCRIPTION OF EMBODIMENTS

The current fast-pace of technology, research, and general knowledge creation has resulted in previous and current methods of knowledge dissemination is inadequate for providing up-to-date knowledge and information on recent developments. Further, knowledge is no longer generated by a few select individuals in select regions. Rather, researchers, professors, experts, and others with knowledge of a given topic, referred to in this disclosure as knowledgeable people, are located around the world and are constantly generating and sharing new ideas.

As a result of the Internet, however, this vast wealth of newly created knowledge from around the world is being shared worldwide in a continuous manner. In some circumstances, this vast knowledge is being shared through social media. For example, knowledgeable people may share knowledge recently acquired through blogs, micro-blogs, and other social media platforms such as FACEBOOK®, TWITTER®, TIK-TOK®, INSTAGRAM®, etc. However, it is often difficult to identify domain-specific, high quality content (e.g., accurate content) and related resources due to the large amount of information, which may include redundant and/or noisy information.

According to one or more embodiments of the present disclosure, operations may be performed to train a machine learning system (e.g., a neural network, such as a graph neural network) to provide content recommendations to users of social networks. As detailed below, the training and recommendations may be based on information gathered from a combination of: user graphs that indicate links between users of corresponding social networks; content graphs that indicate links between the users of the social network and content items interacted with by the users via the corresponding social networks; and resource graphs that indicate links between the content items and external resources included in the content items. The use of the combination of information from the user graphs, the content graphs, and the resource graphs may improve the ability of the machine learning classifier to provide recommendations. Further, in some instances, the improved classifier may be better configured to recommend content that is of a higher quality than recommendations from other systems that are not trained in the manner described herein.

Embodiments of the present disclosure are explained with reference to the accompanying drawings.

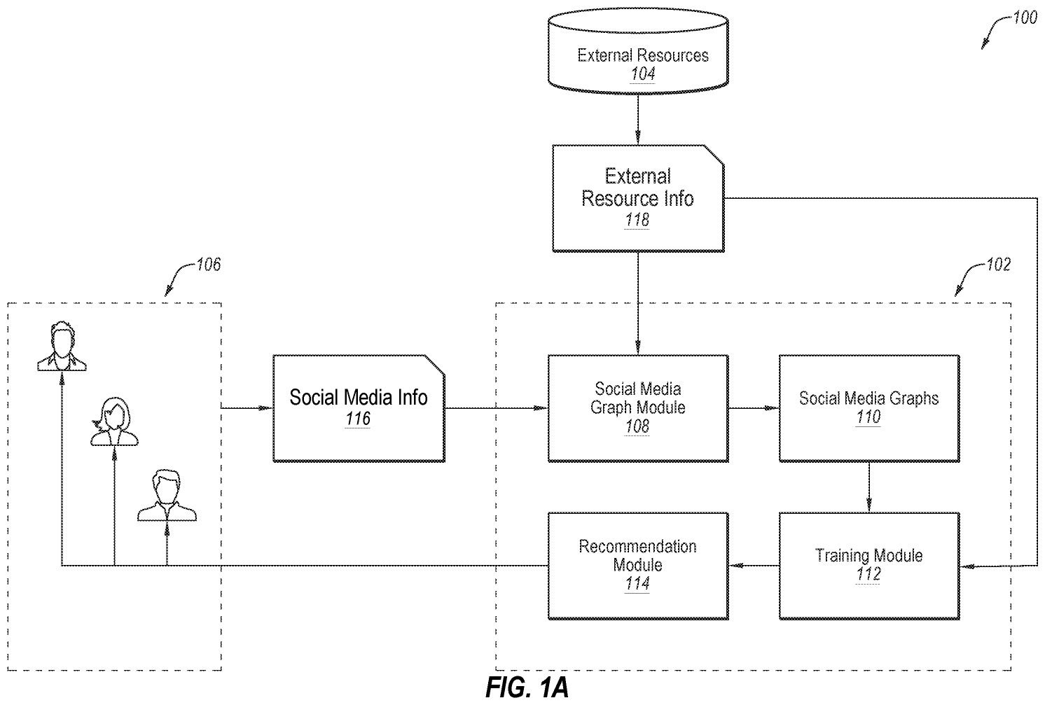

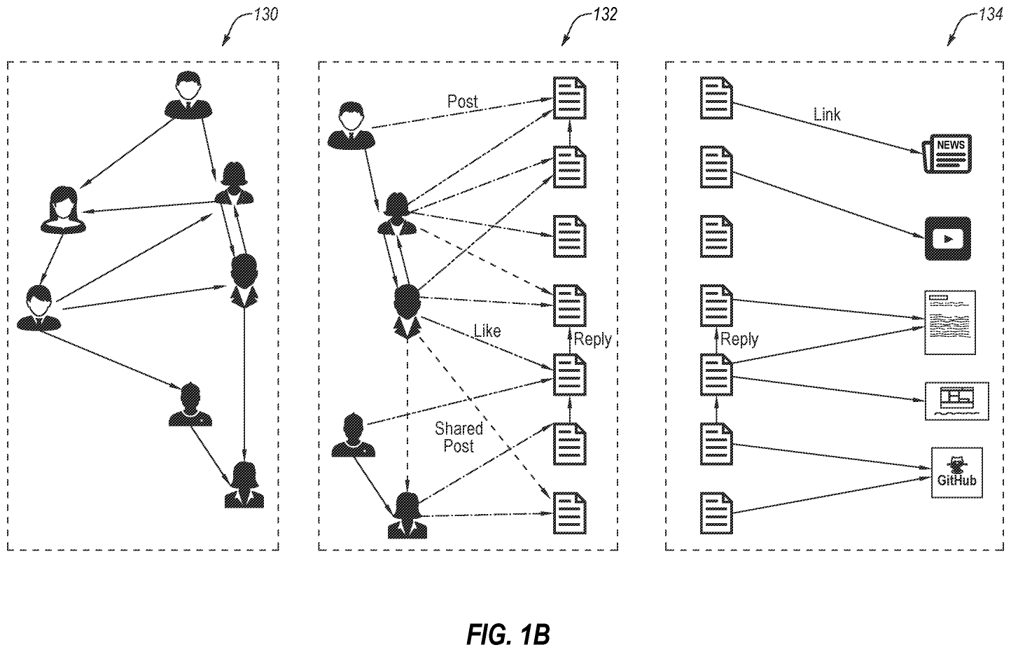

FIG. 1A is a diagram of an example environment 100 related to providing content recommendations, according to one or more embodiments of the present disclosure. The environment 100 may include a recommendation system 102 configured to train a machine learning system—such as a neural network (e.g., a Graph Neural Network (GNN)) to generate content recommendations for one or more users of a social network 106.

The social network 106 may include any suitable platform or combination of platforms that may be used by users to interact with each other through dissemination and interaction of content items. For instance, the social network 106 may include one or more of FACEBOOK®, TWITTER®, TIK-TOK®, INSTAGRAM®, etc. Reference to “content items” may include any item that may be disseminated via the social network 106, including videos, audio, pictures, text, documents, website links (e.g., Uniform Resource Locator (URL) links), comments, etc. Further, reference to “interacting with” a content item may include: sharing a content item with others, forwarding the content item, publishing the content item (e.g., posting the content item on the user's social media page), commenting on the content item (e.g., writing a comment, liking the content item, disliking the content item, etc.), or any other interaction that may be performed with respect to the content item.

In some embodiments, the recommendation system 102 may be configured to perform the training and/or generate the recommendations based on social media information 116 related to the social network 106. The social media information 116 may include user information about users of the social network 106. For example, the user information may include: demographic information about the users; links between users (e.g., connections between users such as “friends”, followers, whom the users are following, etc.); user preferences, user interests, type of content items interacted with by the users, popularity of users, popularity rankings of users, etc. In some embodiments, one or more aspects of the user information may be indicated by meta-data that may be obtained from the respective user profiles.

Additionally or alternatively, the social media information 116 may include content information about content items disseminated via the social network 106. For example, the content information may include information about the types of the respective content items, interactions with the respective content items, types of interactions with the respective content items, the subject matter of the respective content items (e.g., what the content items are depicting, the actual text of the content items, words used in the content items (e.g., verbal and/or written), the respective topics of the content items, etc.), references to external resources 104 that may be included in the respective content items (e.g., links to the external resources 104, mentioning of the external resources 104, etc.), content and content type of the external resources 104 embedded therein, popularity of the content items, rankings of the content items, etc.

In these or other embodiments, the recommendation system 102 may be configured to perform the training and/or generate the recommendations based on external resource information 118 related to external resources 104. The external resources 104 may include online resources that may be independent or separate from the social network 106. For example, the external resources 104 may include third-party webpages or websites, such as news websites, video sites, blog sites, etc. In some embodiments, the external resources 104 may include other social networks that are not included in or part of the social network 106. In the present disclosure, reference to the external resources 104 may also include the content that is published or provided by the external resources 104.

The external resource information 118 may include information about the external resources 104. For example, the external resource information 118 may indicate the type of content provided by the respective external resources 104 (e.g., news content, video content, audio content, movie content, blog content, entertainment content, educational content, medical content, scientific content, fictional content, government content, religious content, etc.), the type of website associated with the external resources 104 (e.g., news sites, educational sites, entertainment sites, social network sites, publication sites, medical sites, government sites, religious sites, corporate sites, private individual sites, non-profit sites, charitable sites, etc.). In these or other embodiments, the external resource information 118 may include a format of the external resources 104 and the content included therein. For example, the external resource information 118 may indicate that the content has a video format, an image format, a textual format, an audio format, an article format, etc. In some embodiments, one or more aspects of the external resource information 118 may be indicated by meta-data that may be obtained from the external resources 104.

The recommendation system 102 may include a social media graph module 108 (“graph module 108”) configured to generate social media graphs 110 based on the social media information 116 and/or the external resource information 118. The graph module 108 may include code and routines configured to enable a computing system to perform one or more operations related to generating the social media graphs 110. Additionally or alternatively, the graph module 108 may be implemented using hardware including a processor, a microprocessor (e.g., to perform or control performance of one or more operations), a field-programmable gate array (FPGA), or an application-specific integrated circuit (ASIC). In some other instances, the graph module 108 may be implemented using a combination of hardware and software. In the present disclosure, operations described as being performed by the graph module 108 may include operations that the graph module 108 may direct a corresponding system to perform.

The social media graphs 110 generated by the graph module 108 may include one or more user graphs The user graphs may indicate links between users of the social network 106. For example, the user graphs may indicate which users are connected to each other via being “friends”, who the users are following, by whom the users are being followed, etc. Further, the user graphs may indicate degrees of connection between users. For example, the user graphs may indicate direct connections between users or indirect connections between users in which different users are connected via one or more intermediate users. FIG. 1B illustrates an example user graph 130.

Additionally, the social media graphs 110 generated by the graph module 108 may include one or more content graphs. The content graphs may indicate links between the users of the social network 106 and content items interacted with by the users. For example, the content graphs may indicate which content items are interacted with by which users. Further the content graphs may indicate the types of interactions performed by the respective users with respect to the corresponding content items. Additionally or alternatively, the content graphs may indicate the types of content items interacted with by which users, the subject matter of the content items, and/or the type of subject matter interacted with by which users. FIG. 1B illustrates an example content graph 132.

Further, the social media graphs 110 generated by the graph module 108 may include one or more resource graphs. The resource graphs may indicate links between the content items disseminated via the social network 106 and external resources included in the content items. For example, the resource graphs may indicate which external resources 104 are included or referenced in which content items. Additionally or alternatively, the resource graphs may indicate the sources of external resources 104, such as the URLs of websites or webpages that correspond to the external resources 104. In these or other embodiments, the resource graphs may indicate links between the content items and one or more of the content of external resources 104, the types of the external resources 104, and/or the subject matter types of the external resources 104. FIG. 1B illustrates an example resource graph 134.

The graph module 108 may be configured to generate the social media graphs 110 according to any suitable technique. For example, the graph module 108 may be configured to obtain the social media information 116 from the social network 106 and derive the links between the users based on the user information included therein. The graph module 108 may then be configured to generate a representation of the links as a user graph. In some embodiments, the format of the user graph may be such that the user graph may be used by a neural network (e.g., an attention network) configured to determine user relevance measures between users of the social network 106 based on the links included in the user graph. Determination of the user relevance measures is discussed in further detail below.

As another example, the graph module 108 may be configured to derive the links between the users and the content items based on the social media information 116. The graph module 108 may then be configured to generate a representation of the links as a content graph. In some embodiments, the format of the content graph may be such that the content graph may be used by a neural network (e.g., an attention network) configured to determine content relevance measures between users of the social network 106 and the content items disseminated therein based on the links included in the content graph. Determination of the content relevance measures is discussed in further detail below.

Additionally or alternatively, the graph module 108 may be configured to obtain the external resource information 118 in addition to the social media information 116. the graph module 108 may be configured to derive the links between the content items and the external resources 104 based on the external resource information 118 and the social media information 116. For example, the graph module 108 may be configured to identify and extract external resource links (e.g., URL's) that may be included in the content items of the social media information 116. In addition, the graph module 108 may be configured to determine which links may correspond to the same external resources 104 and may use such correspondences to identify which content items may refer to the same external resources. In these or other embodiments, the graph module 108 may be configured to extract additional information about the external resources 104 based on the external resource information 118. For example, the graph module 108 may be configured to identify content type, content format, subject matter, etc. of the external resources 104 based on the external resource information 118. In these or other embodiments, the graph module 108 may be configured to obtain one or more aspects of the other external resource information 118 from meta-data of the external resources 104 and/or links of the external resources included in the content items.

The graph module 108 may then be configured to generate a representation of the links between the content items and the external resources 104 as a resource graph. In some embodiments, the format of the resource graph may be such that the resource graph may be used by a neural network (e.g., an attention network) configured to determine resource relevance measures between the external resources 104 and the content items disseminated within the social network 106.

The recommendation system 102 may include a training module 112 configured to train a machine learning system to provide content recommendations. In some embodiments, the training module 112 may be configured to train the machine learning system by generating a user-content relation classifier (“relation classifier”) of the machine learning system based on the social media information 116, the external resource information 118, and the social media graphs 110. The relation classifier may be configured to generate recommendations according to classifications included therein that are based on the social media information 116, the external resource information 118, and the social media graphs 110.

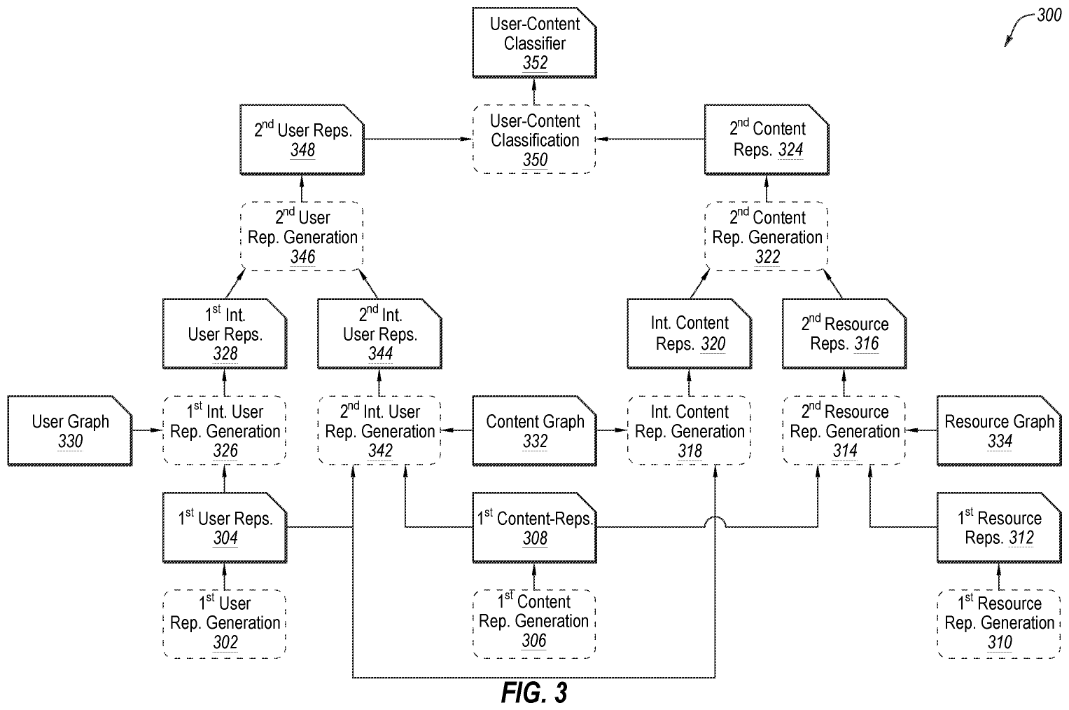

The training module 112 may include code and routines configured to enable a computing system to perform one or more operations related to generating the relation classifier. Additionally or alternatively, the training module 112 may be implemented using hardware including a processor, a microprocessor (e.g., to perform or control performance of one or more operations), a field-programmable gate array (FPGA), or an application-specific integrated circuit (ASIC). In some other instances, the training module 112 may be implemented using a combination of hardware and software. In the present disclosure, operations described as being performed by the training module 112 may include operations that the training module 112 may direct a corresponding system to perform. The training module 112 may be configured to generate the relation classifier using one or more operations described in detail below with respect to FIGS. 3-7.

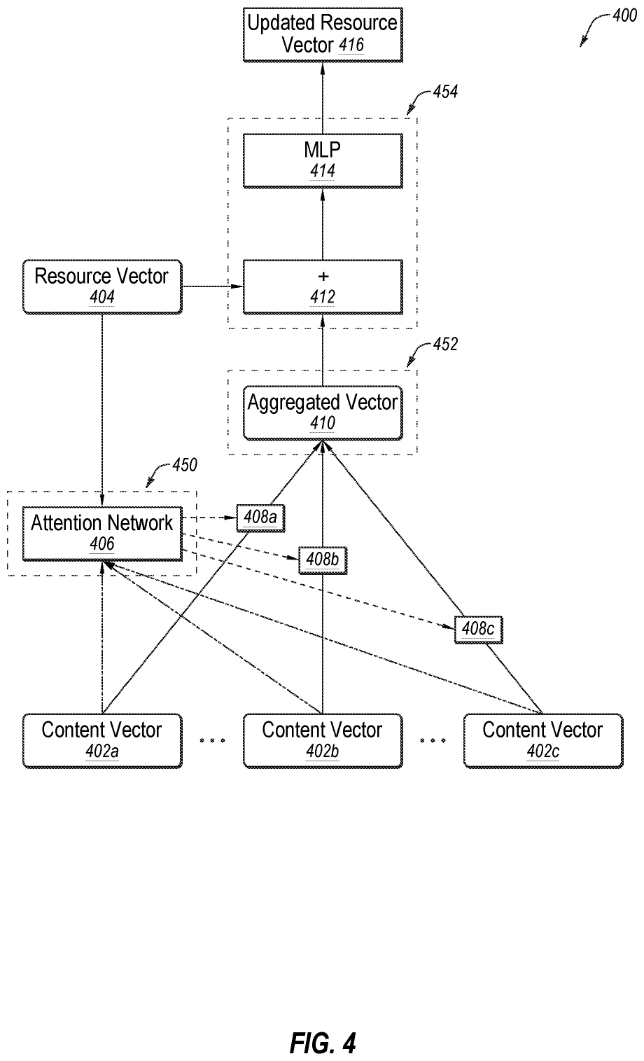

In these or other embodiments, the recommendation system 102 may include a recommendation module 114 configured to obtain a content recommendation using the relation classifier that may be generated by the training module 112. The recommendation module 114 may include code and routines configured to enable a computing system to perform one or more operations related to obtaining the recommendation. Additionally or alternatively, the recommendation module 114 may be implemented using hardware including a processor, a microprocessor (e.g., to perform or control performance of one or more operations), a field-programmable gate array (FPGA), or an application-specific integrated circuit (ASIC). In some other instances, the recommendation module 114 may be implemented using a combination of hardware and software. In the present disclosure, operations described as being performed by the recommendation module 114 may include operations that the recommendation module 114 may direct a corresponding system to perform. The recommendation module 114 may be configured to obtain the using one or more operations described in detail below with respect to FIG. 4.

Modifications, additions, or omissions may be made to the environment 100 without departing from the scope of the present disclosure. For example, additional or fewer operations may be performed than those explicitly described. Further, the number and types of social networks and/or external resources analyzed may vary. In addition, two or more of the graph module 108, the training module 112, or the recommendation module 114 may be implemented together as part of a same module or system. Additionally or alternatively, one or more of the graph module 108, the training module 112, or the recommendation module 114 may be implemented or included in a separate system from one or more of the other modules. Further, the graphs of FIG. 1B are meant to provide illustrative examples of the respective graphs to help understanding of the concepts described herein. The particular formats and depictions are not meant to be limiting.

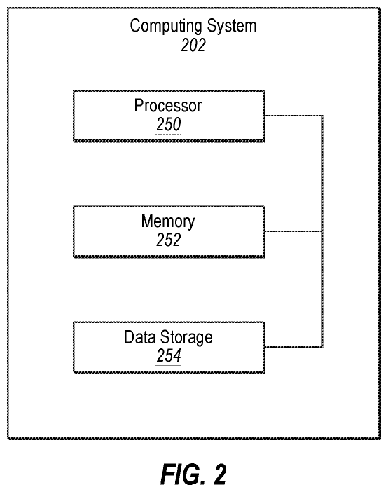

FIG. 2 illustrates a block diagram of an example computing system 202, according to at least one embodiment of the present disclosure. The computing system 202 may be configured to implement or direct one or more operations associated with one or more of the modules described herein (e.g., the graph module 108, the training module 112, and/or the recommendation module 114 of FIG. 1A). The computing system 202 may include a processor 250, a memory 252, and a data storage 254. The processor 250, the memory 252, and the data storage 254 may be communicatively coupled.

In general, the processor 250 may include any suitable special-purpose or general-purpose computer, computing entity, or processing device including various computer hardware or software modules and may be configured to execute instructions stored on any applicable computer-readable storage media. For example, the processor 250 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 250 may include any number of processors configured to, individually or collectively, perform or direct performance of any number of operations described in the present disclosure. Additionally, one or more of the processors may be present on one or more different electronic devices, such as different servers.

In some embodiments, the processor 250 may be configured to interpret and/or execute program instructions and/or process data stored in the memory 252, the data storage 254, or the memory 252 and the data storage 254. In some embodiments, the processor 250 may fetch program instructions from the data storage 254 and load the program instructions in the memory 252. After the program instructions are loaded into memory 252, the processor 250 may execute the program instructions.

For example, in some embodiments, one or more of the above mentioned modules may be included in the data storage 254 as program instructions. The processor 250 may fetch the program instructions of a respective module from the data storage 254 and may load the program instructions of the respective module in the memory 252. After the program instructions of the respective module are loaded into memory 252, the processor 250 may execute the program instructions such that the computing system may implement the operations associated with the respective module as directed by the instructions.

The memory 252 and the data storage 254 may include computer-readable storage media for carrying or having computer-executable instructions or data structures stored thereon. Such computer-readable storage media may include any available media that may be accessed by a general-purpose or special-purpose computer, such as the processor 250. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 250 to perform a certain operation or group of operations.

Modifications, additions, or omissions may be made to the computing system 202 without departing from the scope of the present disclosure. For example, in some embodiments, the computing system 202 may include any number of other components that may not be explicitly illustrated or described.

FIG. 3 illustrates an example flow of operations 300 (“operations 300”) configured to generate a user-content classifier 352, according to at least one embodiment described in the present disclosure. The operations 300 may be performed by any suitable system, apparatus, or device. For example, the one or more of the modules of FIG. 1A or the computing system 202 of FIG. 2 (e.g., as directed by one of the modules) may perform one or more of the operations associated with the operations 300. Although illustrated with discrete blocks, the steps and operations associated with one or more of the blocks of the operations 300 may be divided into additional blocks, combined into fewer blocks, or eliminated, depending on the particular implementation.

The operations 300 may include an operation 302 at which first user representations 304 of users of a social network (e.g., the social network 106 of FIG. 1A) may be generated. The first user representations 304 may be initial representations of the users in some embodiments. Further, the first user representations 304 may each represent user information associated with a respective user of the social network. The user information may include any of the user information described above with respect to the social media information 116 of FIG. 1A.

In some embodiments, each of the first user representations 304 may be formatted as vectors (referred to as “user vectors”) that include the different types of user information associated with each respective user. For example, in some embodiments, the user information may be obtained by analyzing the respective profiles and patterns of the users on the social network. In these or other embodiments, the one or more aspects of the user information may be identified from meta-data about the respective users. Additionally or alternatively, the different types of user information for a respective user may be aggregated together as a user vector that corresponds to the respective user.

For example, in some embodiments, a pre-trained model (e.g., a BERT model, an ELMO model, a Fasttext model) may be used to generate a user vector that may be a summary of the user information. For example, text of the user information may be provided as an input to the pre-trained model and the pre-trained model may output the user vector. In these or other embodiments, a linear projection may be applied to the one or more of the user vectors to change the dimensions of the corresponding user vectors.

Additionally, the operations 300 may include an operation 306 at which first content representations 308 of content items disseminated via the social network may be generated. The first content representations 308 may be initial representations of the content items in some embodiments. Further, the first content representations 308 may each represent content information associated with a respective content item. The content information may include any of the content information described above with respect to the social media information 116 of FIG. 1A.

In some embodiments, each of the first content representations 308 may be formatted as vectors (referred to as “content vectors”) that include the different types of content information associated with each respective content item. For example, in some embodiments, the content information may be obtained by analyzing the respective content items to identify the content item information that corresponds to the respective content items. For instance, subject matter of the content items may be identified by parsing text, performing image recognition, performing audio recognition, etc. Additionally or alternatively, the content items may be analyzed to determine types of media included in the content items, whether links to external resources are included in the content items, types of interactions performed with respect to the content items, etc. Additionally or alternatively, the different types of content information for a respective content item may be aggregated together as a content vector that corresponds to the respective content item.

For example, in some embodiments, a pre-trained model (e.g., a BERT model, an ELMO model, a Fasttext model) may be used to generate a content vector that may be a summary of the content information. For example, the content information may be provided as an input to the pre-trained model and the pre-trained model may output the content vector. In these or other embodiments, a linear projection may be applied to the one or more of the content vectors to change the dimensions of the corresponding content vectors.

Further, the operations 300 may include an operation 310 at which first resource representations 312 of external resources that may be referenced in the content items may be generated. The first resource representations 312 may be initial representations of the external resources in some embodiments. Further, the first resource representations 312 may each represent resource information associated with a respective external resource. The resource information may include any of the external resource information 118 described with respect to FIG. 1A in some embodiments.

In some embodiments, each of the first resource representations 312 may be formatted as vectors (referred to as “resource vectors”) that include the different types of resource information associated with each respective external resource. For example, in some embodiments, the resource information may be obtained by analyzing the respective external resources to identify the resource information that corresponds to the respective content items.

For instance, subject matter of the external resources may be identified by parsing text, performing image recognition, performing audio recognition, etc. with respect to the external resources. Additionally or alternatively, the external resources may be analyzed to determine types of media included in the external resources. For example, media types that may be identified may include papers, news, videos, slides, audio, code, etc. In these or other embodiments, the external resources may be analyzed to determine timestamps associated with the external resources. In some embodiments, meta-data of the external resources may be analyzed to identify one or more aspects of the resource information.

In some embodiments, a pre-trained model may be used to provide a textual summary of the subject matter of the respective external resources In these or other embodiments, the textual summary may be generated in a vector representation.

Additionally or alternatively, one-hot encoding may be performed with respect to the media types of the external resources to represent the media types into vector format. In these or other embodiments, the timestamps may be formatted into vectors as well using any suitable technique. In some embodiments, the subject matter vector, the media type vector, and the timestamp vector of a respective external resource may be combined (e.g., concatenated) to generate a resource vector that represents the resource information of the respective external resource. In these or other embodiments, a linear projection may be applied to the one or more of the resource vectors to change the dimensions of the corresponding resource vectors.

The operations 300 may also include an operation 314 at which second resource representations 316 may be generated based on the first resource representations 312, the first content representations 308, and a resource graph 334. The resource graph 334 may be analogous to the resource graph of the social media graphs 110 described above with respect to FIG. 1A. In these or other embodiments, the second resource representations 316 may be considered updated versions of the first resource representations 312. For example, the second resource representations 316 may be formatted as second resource vectors that represent additional information and relationships as compared to the initial resource vectors and as determined based on the first resource representations 312, the first content representations 308, and the resource graph 334. FIG. 4 illustrates example operations that may be performed to generate the second resource representations 316.

The operations 300 may also include operations 318 and 322 which may be used to generate second content representations 324 of the content items. The operations 318 and 322 may include generation of the second content representations 324 based on the first content representations 308, the first user representations 304, a content graph 332, and the second resource representations 316. The content graph 332 may be analogous to the content graph of the social media graphs 110 described above with respect to FIG. 1A.

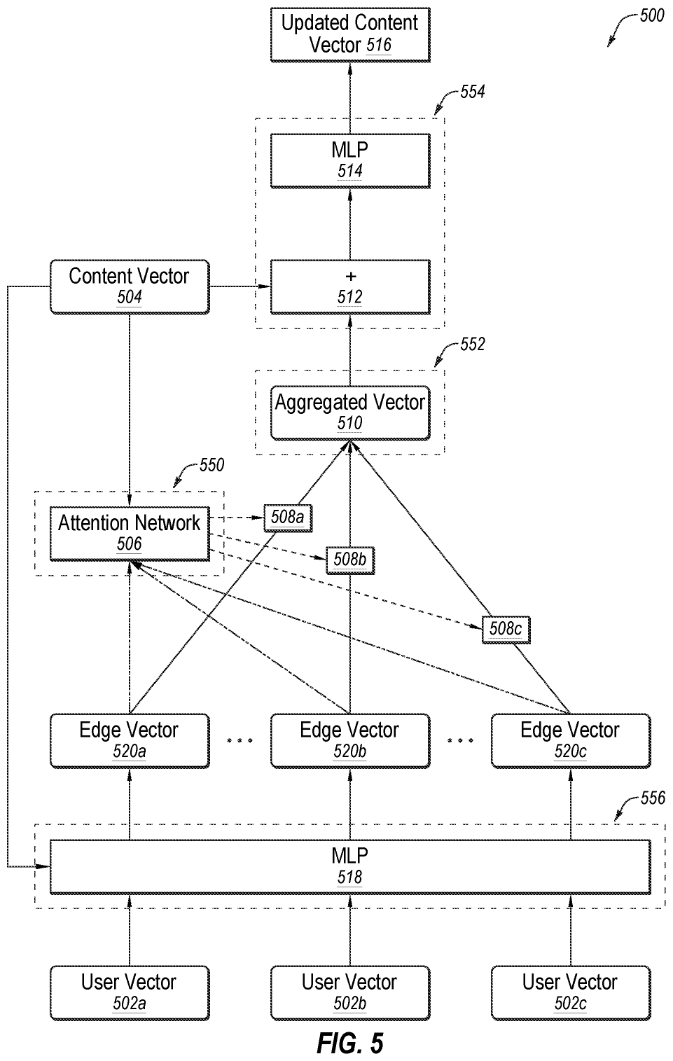

For example, the operation 318 may include the generation of intermediate content representations 320 based on the first content representations 308, the first user representations 304, and the content graph 332. In these or other embodiments, the intermediate content representations 320 may be considered updated versions of the first content representations 308. For example, the intermediate content representations 320 may be formatted as intermediate content vectors that represent additional information and relationships as determined based on the first user representations 304, the first content representations 308, and the content graph 332 and as compared to the initial content vectors. FIG. 5 illustrates example operations that may be performed to generate the intermediate content representations 320.

The operation 322 may include generating the second content representations 324 based on the intermediate content representations 320 and the second resource representations 316. For example, in some embodiments, each respective intermediate content representation 320 may be combined with each respective second resource representation 316. In some embodiments, the combining may include concatenating each respective intermediate content vector with each respective second resource vector. Each concatenation may include one intermediate content vector and one second resource vector to generate a second content vector that corresponds to a respective second content representation 324.

In these or other embodiments, the operation 322 may include applying a nonlinear transformation to each combination of respective intermediate content representations 320 and respective second resource representations 316 to obtain each respective second content representation 324. For example, in some embodiments, each combination may be provided to a Feedforward Neural Network (FNN) (e.g., a multilayer perceptron (MLP)), which may output the respective second content representations 324 as the second content vectors.

The operations 300 may also include operations 326, 342, and 346 which may be used to generate second user representations 348 of the users. The operations 326, 342, and 346 may include generation of the second user representations 348 based on the first content representations 308, the first user representations 304, the content graph 332, and a user graph 330. The user graph 330 may be analogous to the user graph of the social media graphs 110 described above with respect to FIG. 1A.

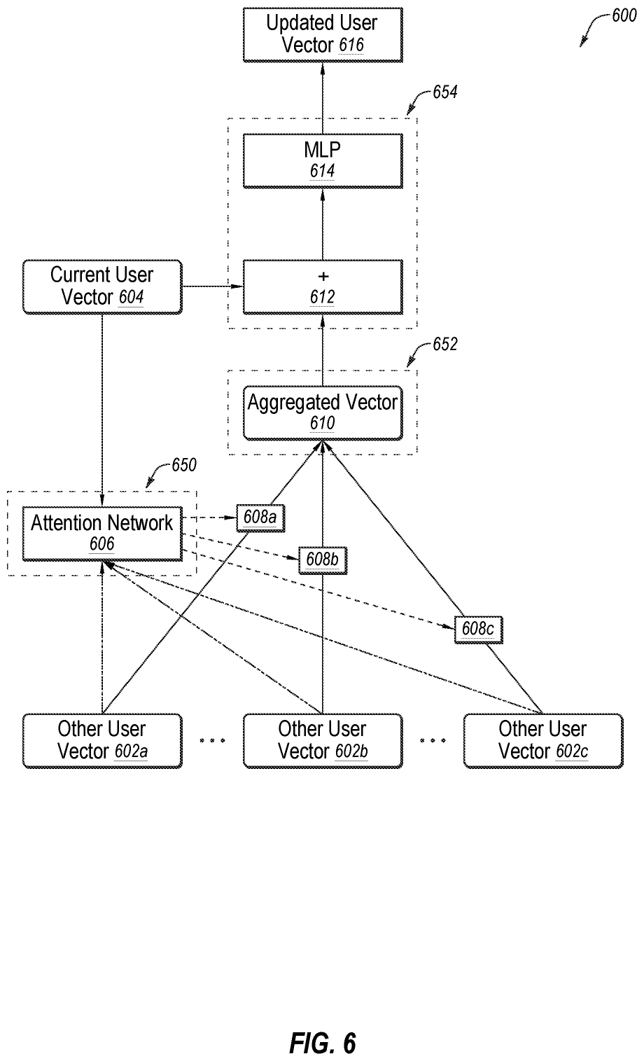

The operation 326 may include the generation of first intermediate user representations 328 based on the first user representations 304 and the user graph 330. In these or other embodiments, the first intermediate user representations 328 may be considered updated versions of the first user representations 304. For example, the first intermediate user representations 328 may be formatted as first intermediate user vectors that represent additional information and relationships as determined based on the first user representations 304 and the user graph 330 and as compared to the initial user vectors. FIG. 6 illustrates example operations that may be performed to generate the first intermediate user representations 328.

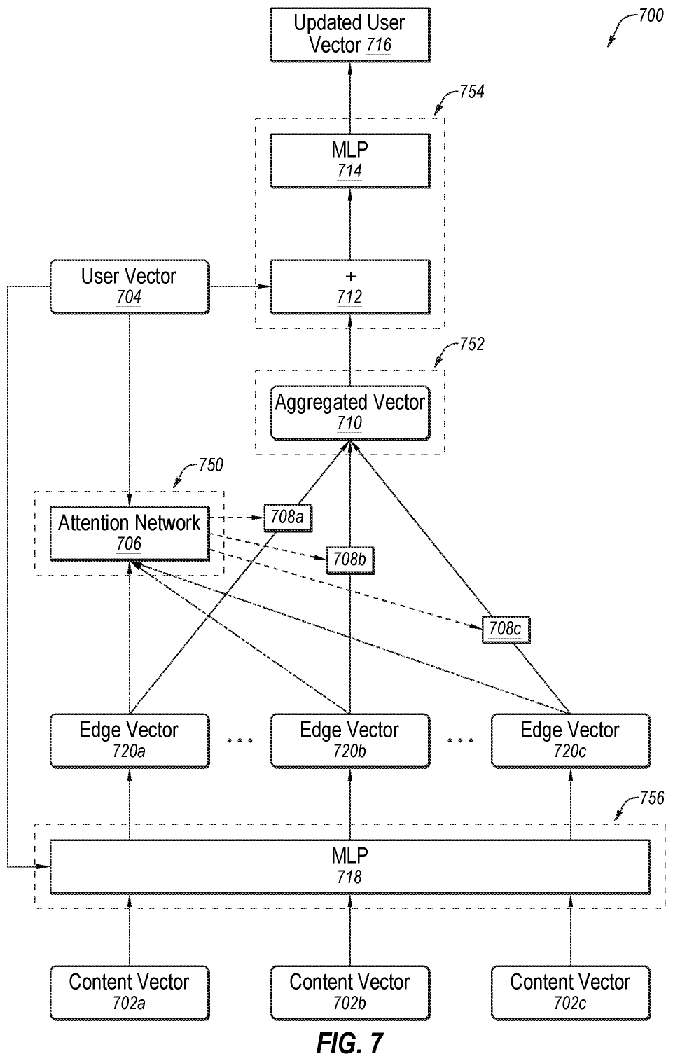

The operation 342 may include the generation of second intermediate user representations 344 based on the first user representations 304, the first content representations 308, and the content graph 332. In these or other embodiments, the second intermediate user representations 344 may be considered updated versions of the first user representations 304. For example, the second intermediate user representations 344 may be formatted as first intermediate user vectors that represent additional information and relationships as determined based on the first user representations 304, the first content representations 308, and the content graph 332 and as compared to the initial user vectors. FIG. 7 illustrates example operations that may be performed to generate the second intermediate user representations 344.

The operation 346 may include generating the second user representations 324 based on the first intermediate user representations 328 and the second intermediate user representations 344. For example, in some embodiments, the operation 346 may include combining each respective first intermediate user representation 328 with each respective second intermediate user representation 344. In some embodiments, the combining may include concatenating each respective first intermediate user vector with each respective second intermediate user vector. Each concatenation may include one first intermediate user vector and one second intermediate user vector to generate a second user vector that corresponds to a respective second user representations 324.

In these or other embodiments, the operation 346 may include applying a nonlinear transformation to each combination of respective first intermediate user representations 328 and respective second intermediate user representations 344 to obtain each respective second user representation 348. For example, in some embodiments, each combination may be provided to a Feedforward Neural Network (FNN) (e.g., a multilayer perceptron (MLP)), which may output the respective second user representations 348 as the second user vectors.

Additionally or alternatively, the operations 300 may include an operation 350 that may include generating the user-content classifier 352 (“classifier 352”) based on the second user representations 348 and the second content representations 324. For example, in some embodiments, the operation 350 may include combining each respective second user representation 348 with each respective content representation 324. In some embodiments, the combining may include concatenating each respective second user vector with each respective second content vector. Each concatenation may include one second user vector and one second content vector to generate a user-content classification that may be included in the classifier 352. In some embodiments, the classifier 352 may be configured as a Feedforward Neural Network (FNN) classifier such as a multilayer perceptron (MLP).

Modifications, additions, or omissions may be made to the operations 300 without departing from the scope of the present disclosure. For example some of the operations may be implemented in differing order than described. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

FIG. 4 illustrates an example flow of operations 400 (“operations 400”) configured to generate an updated resource vector 416, according to at least one embodiment described in the present disclosure. The operations 400 may be performed by any suitable system, apparatus, or device. For example, one or more of the modules of FIG. 1A or the computing system 202 of FIG. 2 (e.g., as directed by one of the modules) may perform one or more of the operations associated with the operations 400. Although illustrated with discrete blocks, the steps and operations associated with one or more of the blocks of the operations 400 may be divided into additional blocks, combined into fewer blocks, or eliminated, depending on the particular implementation.

As indicated with respect to FIG. 3, in some embodiments, the operation 314 of FIG. 3 may include the operations 400 such that the operations 400 may be used to generate the second resource representations 316 described with respect to FIG. 3. For example, in some embodiments, the updated resource vector 416 may be a resource vector that corresponds to a respective second resource representation 316. Further, the updated resource vector 416 may be an updated version of a resource vector 404, which may be an initial resource vector that corresponds to a respective first resource representation 312 of FIG. 3. In these or other embodiments, the operations 400 may accordingly be performed with respect to each resource vector 404 that corresponds to each respective first resource representation 312 to generate a different updated resource vector 416 for each second resource representation 316.

In some embodiments, the operations 400 may include an operation 450 that may include determining resource relevance measures 408 based on the resource vector 404 and content vectors 402. The content vectors 402 may each correspond to a respective content item and may be examples of the first content representations 308 of FIG. 3. In some embodiments, a content vector 402 may be obtained for each content item.

Additionally or alternatively, the operation 450 may include determining a resource relevance measure 408 between each of the content items and the external resource that corresponds to the resource vector 404. Each respective resource relevance measure 408 may accordingly be between a respective content item that corresponds to a respective content vector 402 and the external resource that corresponds to the resource vector 404. For example, a first resource relevance measure 408a may be determined with respect to the external resource that corresponds to the resource vector 404 and a first content item that corresponds to a first content vector 402a; a second resource relevance measure 408b may be determined with respect to the external resource that corresponds to the resource vector 404 and a second content item that corresponds to a second content vector 402b; and a third resource relevance measure 408c may be determined with respect to the external resource that corresponds to the resource vector 404 and a third content item that corresponds to a third content vector 402c.

The resource relevance measures 408 may each indicate a degree of connectivity between the respective content item and the external resource. In some embodiments, the degree of connectivity may be determined by an attention network 406 configured to determine the degree of connectivity by analyzing the content vectors 402, the resource vector 404, and relationships between the external resource and the corresponding content items, which may be indicated by a resource graph (not expressly illustrated in FIG. 4), such as the resource graph 334 of FIG. 3. For example, the resource relevance measures 408 may be based on which of the respective content items provide a link to the external resource, how many of the respective content items provide a link to the external resource, which types of respective content items provide a link to the external resource, etc.

In these or other embodiments, the resource relevance measures 408 may be used to weight the respective content vectors 402. The weighting may be based on the degrees of connectivity, in which a higher degree may provide a higher weight.

In some embodiments, the operations 400 may include an operation 452. The operation 452 may include the generation of an aggregated content vector 410 based on the weighted content vectors 402. For example, the weighted content vectors 402 may be concatenated to generate the aggregated content vector 410. The aggregated content vector 410 may accordingly be an aggregated content representation that collectively represents the content items. Additionally or alternatively, the aggregated content vector 410 may represent a collective relationship between the content items and the external resource that corresponds to the resource vector 404.

The operations 400 may include an operation 454 at which the aggregated content vector 410 and the resource vector 404 may be combined. For example, in some embodiments, the operation 454 may include a concatenating operation 412 that may concatenate the aggregated content vector 410 and the resource vector 404. In these or other embodiments, the operation 454 may include providing the combination of the aggregated content vector 410 and the resource vector 404 to a a multilayer perceptron (MLP) 414, which may output the updated resource vector 416.

Modifications, additions, or omissions may be made to the operations 400 without departing from the scope of the present disclosure. For example some of the operations may be implemented in differing order than described. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

FIG. 5 illustrates an example flow of operations 500 (“operations 500”) configured to generate an updated content vector 516, according to at least one embodiment described in the present disclosure. The operations 500 may be performed by any suitable system, apparatus, or device. For example, one or more of the modules of FIG. 1A or the computing system 202 of FIG. 2 (e.g., as directed by one of the modules) may perform one or more of the operations associated with the operations 500. Although illustrated with discrete blocks, the steps and operations associated with one or more of the blocks of the operations 500 may be divided into additional blocks, combined into fewer blocks, or eliminated, depending on the particular implementation.

As indicated with respect to FIG. 3, in some embodiments, the operation 318 of FIG. 3 may include the operations 500 such that the operations 500 may be used to generate the intermediate content representations 320 described with respect to FIG. 3. For example, in some embodiments, the updated content vector 516 may be a content vector that corresponds to a respective intermediate content representation 320. Further, the updated content vector 516 may be an updated version of a content vector 504, which may be an initial content vector that corresponds to a respective first content representation 308 of FIG. 3. In these or other embodiments, the operations 500 may accordingly be performed with respect to each content vector 504 that corresponds to each respective first content representation 308 to generate a different updated content vector 516 for each intermediate content representation 320.

In some embodiments, the operations 500 may include an operation 556 that may include determining edge vectors 520 based on the content vector 504 and user vectors 502. The user vectors 502 may each correspond to a respective user of a social network and may be examples of the first user representations 304 of FIG. 3. In some embodiments, a user vector 502 may be obtained for each user.

Additionally or alternatively, the operation 556 may include determining an edge vector 520 for each of the user vectors 502. Each edge vector 520 may be generated based on a type of interaction performed by the respective user with respect to the content item that corresponds to the content vector 504. For example, the different interactions may include original postings of the corresponding content item (e.g., posting a tweet), sharing of the corresponding content item (e.g., retweeting a tweet), liking the corresponding content item, commenting on the corresponding content item, etc. In some embodiments, the type of interaction may be identified based on a user graph (not expressly illustrated in FIG. 5), such as the user graph 330 of FIG. 3 and/or information that may be included in the content vector 504 and/or the respective user vectors 502.

Each respective edge vector 520 may accordingly be generated based on an interaction performed by a respective user that corresponds to a respective user vector 502 with respect to the content item that corresponds to the content vector 504. For example, a first edge vector 520a may be determined based on a first interaction by a first user that corresponds to a first user vector 502a with the content item that corresponds to the content vector 504. Similarly, a second edge vector 520b may be determined based on a second interaction by a second user that corresponds to a second user vector 502b with the content item that corresponds to the content vector 504. As another example, a third edge vector 520c may be determined based on a third interaction by a third user that corresponds to a third user vector 502c with the content item that corresponds to the content vector 504.

In these or other embodiments, the edge vectors 520 may be generated to have different weights depending on the different types of interactions. Further, in some embodiments, the edge vectors 520 may be updated versions of the respective user vectors 502 in which the different weights are applied to the respective user vectors 502. Additionally or alternatively, the operation 556 may include providing the content vector 504 and the user vectors 502 to a multilayer perceptron (MLP) 518, which may output the respective edge vectors 520.

In some embodiments, the operations 500 may include an operation 550 that may include determining content relevance measures 508 based on the content vector 504 and the edge vectors 520. Additionally or alternatively, the operation 550 may include determining a content relevance measure 508 between each of the users and the content item that corresponds to the content vector 504. Each respective content relevance measure 508 may accordingly be between a respective user that corresponds to a respective edge vector 520 and the content item that corresponds to the content vector 504. For example, a first content relevance measure 508a may be determined with respect to the content item that corresponds to the content vector 502 and a first user that corresponds to a first edge vector 520a; a second content relevance measure 508b may be determined with respect to the content item that corresponds to the content vector 502 and a second user that corresponds to a second edge vector 520b; and a third content relevance measure 508c may be determined with respect to the content item that corresponds to the content vector 502 and a third user that corresponds to a third edge vector 520c.

The content relevance measures 508 may each indicate a degree of connectivity between the respective user and the content item. In some embodiments, the degree of connectivity may be determined by an attention network 506 configured to determine the degree of connectivity by analyzing the edge vectors 520, the content vector 504, and relationships between the content item and the corresponding users (e.g., relationships based on interactions and interaction types), which may be indicated by the content graph. For example, the content relevance measures 508 may be based on which of the respective users generated or otherwise interacted with the content item, how many of the respective users interacted with the content item, which types of interactions were performed by the respective users with respect to the content item, etc.

In these or other embodiments, the content relevance measures 508 may be used to weight the respective edge vectors 520. The weighting may be based on the degrees of connectivity, in which a higher degree may provide a higher weight.

In some embodiments, the operations 500 may include an operation 552. The operation 552 may include the generation of an aggregated user vector 510 based on the weighted edge vectors 520. For example, the weighted edge vectors 520 may be concatenated to generate the aggregated user vector 510. The aggregated user vector 510 may accordingly be an aggregated user representation that collectively represents the users that correspond to the user vectors 502. Additionally or alternatively, the aggregated user vector 510 may represent a collective relationship between the users and the content item that corresponds to the content vector 504.

The operations 500 may include an operation 554 at which the aggregated user vector 510 and the content vector 504 may be combined. For example, in some embodiments, the operation 554 may include a concatenating operation 512 that may concatenate the aggregated user vector 510 and the content vector 504. In these or other embodiments, the operation 554 may include providing the combination of the aggregated user vector 510 and the content vector 504 to a a multilayer perceptron (MLP) 514, which may output the updated content vector 516.

Modifications, additions, or omissions may be made to the operations 500 without departing from the scope of the present disclosure. For example some of the operations may be implemented in differing order than described. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

FIG. 6 illustrates an example flow of operations 600 (“operations 600”) configured to generate an updated current user vector 616, according to at least one embodiment described in the present disclosure. The operations 600 may be performed by any suitable system, apparatus, or device. For example, one or more of the modules of FIG. 1A or the computing system 202 of FIG. 2 (e.g., as directed by one of the modules) may perform one or more of the operations associated with the operations 400. Although illustrated with discrete blocks, the steps and operations associated with one or more of the blocks of the operations 600 may be divided into additional blocks, combined into fewer blocks, or eliminated, depending on the particular implementation.

As indicated with respect to FIG. 3, in some embodiments, the operation 326 of FIG. 3 may include the operations 600 such that the operations 600 may be used to generate the first intermediate user representations 328 described with respect to FIG. 3. For example, in some embodiments, the updated current user vector 616 may be a user vector that corresponds to a respective first intermediate user representation 328. Further, the updated current user vector 616 may be an updated version of a current user vector 604, which may be an initial user vector that corresponds to a respective first user representation 302 of FIG. 3. In these or other embodiments, the operations 600 may accordingly be performed with respect to each current user vector 604 that corresponds to each respective first user representation 304 to generate a different updated current user vector 616 for each first intermediate user representation 328.

Additionally or alternatively, as indicated below, the updated current user vector 616 may be updated based on links between a particular user of a social network and other users of the social network. The current user vector 604 may correspond to the particular user and other user vectors 602 may correspond to the other users. The other user vectors 602 may accordingly also be examples of the first user representations 304 of FIG. 3. In some embodiments, the other users may be those users that are directly connected to the particular user and/or indirectly connected to the particular user.

In some embodiments, the operations 600 may include an operation 650 that may include determining user relevance measures 608 based on the current user vector 604 and the other user vectors 602. Additionally or alternatively, the operation 650 may include determining a user relevance measure 608 between each of the other users and the particular user. Each respective user relevance measure 608 may accordingly be between a respective other user that corresponds to a respective other user vector 602 and the particular user that corresponds to the current user vector 604. For example, a first user relevance measure 608a may be determined with respect to the particular user and a first other user that corresponds to a first other user vector 602a; a second user relevance measure 608b may be determined with respect to the particular user and a second other user that corresponds to a second other user vector 602b; and a third user relevance measure 608c may be determined with respect to the particular user that corresponds to the current user vector 604 and a third other user that corresponds to a third other user vector 602c.

The user relevance measures 608 may each indicate a degree of connectivity between the respective other user and the particular user. In some embodiments, the degree of connectivity may be determined by an attention network 606 configured to determine the degree of connectivity by analyzing the other user vectors 602, the current user vector 604, and relationships between the particular user and the corresponding other users, which may be indicated by a user graph (not expressly illustrated in FIG. 6), such as the user graph 330 of FIG. 3. For example, the user relevance measures 608 may be based on which users are connected to the particular user, how many different users are connected to the particular user, a degree of connectivity between the particular user and the other users, etc.

In these or other embodiments, the user relevance measures 608 may be used to weight the respective other user vectors 502. The weighting may be based on the degrees of connectivity, in which a higher degree may provide a higher weight.

In some embodiments, the operations 600 may include an operation 652. The operation 652 may include the generation of an aggregated other user vector 610 based on the weighted other user vectors 602. For example, the weighted other user vectors 602 may be concatenated to generate the aggregated other user vector 610. The aggregated other user vector 610 may accordingly be an aggregated user representation that collectively represents the other users. Additionally or alternatively, the aggregated other user vector 610 may represent a collective relationship between the other users and the particular user that corresponds to the current user vector 604.

The operations 600 may include an operation 654 at which the aggregated other user vector 610 and the current user vector 604 may be combined. For example, in some embodiments, the operation 654 may include a concatenating operation 612 that may concatenate the aggregated other user vector 610 and the current user vector 604. In these or other embodiments, the operation 654 may include providing the combination of the aggregated other user vector 610 and the current user vector 604 to a multilayer perceptron (MLP) 614, which may output the updated current user vector 616.

Modifications, additions, or omissions may be made to the operations 600 without departing from the scope of the present disclosure. For example some of the operations may be implemented in differing order than described. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

FIG. 7 illustrates an example flow of operations 700 (“operations 700”) configured to generate an updated user vector 716, according to at least one embodiment described in the present disclosure. The operations 700 may be performed by any suitable system, apparatus, or device. For example, one or more of the modules of FIG. 1A or the computing system 202 of FIG. 2 (e.g., as directed by one of the modules) may perform one or more of the operations associated with the operations 700. Although illustrated with discrete blocks, the steps and operations associated with one or more of the blocks of the operations 700 may be divided into additional blocks, combined into fewer blocks, or eliminated, depending on the particular implementation.

As indicated with respect to FIG. 3, in some embodiments, the operation 342 of FIG. 3 may include the operations 700 such that the operations 700 may be used to generate the second intermediate user representations 344 described with respect to FIG. 3. For example, in some embodiments, the updated user vector 716 may be a user vector that corresponds to a respective second intermediate user representation 344. Further, the updated user vector 716 may be an updated version of a user vector 704, which may be an initial user vector that corresponds to a respective first user representation 304 of FIG. 3. In these or other embodiments, the operations 700 may accordingly be performed with respect to each user vector 704 that corresponds to each respective first user representation 304 to generate a different updated user vector 716 for each second intermediate user representation 344.

In some embodiments, the operations 700 may include an operation 756 that may include determining edge vectors 720 based on the user vector 704 and content vectors 702. The content vectors 702 may each correspond to a respective content item disseminated via a social network and may be examples of the first content representations 308 of FIG. 3. In some embodiments, a content vector 702 may be obtained for each content item.

Additionally or alternatively, the operation 756 may include determining an edge vector 720 for each of the content vectors 702. Each edge vector 720 may be generated based on a type of interaction performed by the user that corresponds to the user vector 704 with respect to the respective content items that correspond to the content vectors 702. In some embodiments, the type of interaction may be identified based on a user graph (not expressly illustrated in FIG. 7), such as the user graph 330 of FIG. 3 and/or information that may be included in the user vector 704 and/or the respective content vectors 702.

Each respective edge vector 720 may accordingly be generated based on an interaction performed by the user that corresponds to the user vector 704 with respect to the respective content items that corresponds to the content vectors 702. For example, a first edge vector 720a may be determined based on a first interaction by the user that corresponds to the user vector 704 with respect to a first content item that corresponds to a first content vector 702a. Similarly, a second edge vector 720b may be determined based on a second interaction by the user that corresponds to the user vector 704 with respect to a second content item that corresponds to a second content vector 702b. As another example, a third edge vector 720c may be determined based on a third interaction by the user that corresponds to the user vector 704 with respect to a third content item that corresponds to a third content vector 702c.

In these or other embodiments, the edge vectors 720 may be generated to have different weights depending on the different types of interactions. Further, in some embodiments, the edge vectors 720 may be updated versions of the respective content vectors 702 in which the different weights are applied to the respective content vectors 702. Additionally or alternatively, the operation 756 may include providing the user vector 704 and the content vectors 702 to a a multilayer perceptron (MLP) 718, which may output the respective edge vectors 720.

In some embodiments, the operations 700 may include an operation 750 that may include determining content relevance measures 708 based on the user vector 704 and the edge vectors 720. Additionally or alternatively, the operation 750 may include determining a content relevance measure 708 between each of the content items and the user that corresponds to the user vector 704. Each respective content relevance measure 708 may accordingly be between a respective content item that corresponds to a respective edge vector 720 and the user that corresponds to the user vector 704. For example, a first content relevance measure 708a may be determined with respect to the user that corresponds to the user vector 702 and a first content item that corresponds to a first edge vector 720a; a second content relevance measure 708b may be determined with respect to the user that corresponds to the user vector 702 and a second content item that corresponds to a second edge vector 720b; and a third content relevance measure 708b may be determined with respect to the user that corresponds to the user vector 702 and a third content item that corresponds to a third edge vector 720c.

The content relevance measures 708 may each indicate a degree of connectivity between the respective content item and the user. In some embodiments, the degree of connectivity may be determined by an attention network 706 configured to determine the degree of connectivity by analyzing the edge vectors 720, the user vector 704, and relationships between the user and the corresponding content items (e.g., relationships based on interactions and interaction types), which may be indicated by the content graph. For example, the content relevance measures 708 may be based on with which of the respective content items the user interacted, how many of the respective content items with which the user interacted, with which types of the respective content items the user interacted, etc.

In these or other embodiments, the content relevance measures 708 may be used to weight the respective edge vectors 720. The weighting may be based on the degrees of connectivity, in which a higher degree may provide a higher weight.

In some embodiments, the operations 700 may include an operation 752. The operation 752 may include the generation of an aggregated content vector 710 based on the weighted edge vectors 720. For example, the weighted edge vectors 720 may be concatenated to generate the aggregated content vector 710. The aggregated content vector 710 may accordingly be an aggregated content representation that collectively represents the content items that correspond to the content vectors 702. Additionally or alternatively, the aggregated content vector 710 may represent a collective relationship between the content items and the user that corresponds to the user vector 704.

The operations 700 may include an operation 754 at which the aggregated content vector 710 and the user vector 704 may be combined. For example, in some embodiments, the operation 754 may include a concatenating operation 712 that may concatenate the aggregated content vector 710 and the user vector 704. In these or other embodiments, the operation 754 may include providing the combination of the aggregated content vector 710 and the user vector 704 to a multilayer perceptron (MLP) 714, which may output the updated user vector 716.

Modifications, additions, or omissions may be made to the operations 700 without departing from the scope of the present disclosure. For example some of the operations may be implemented in differing order than described. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

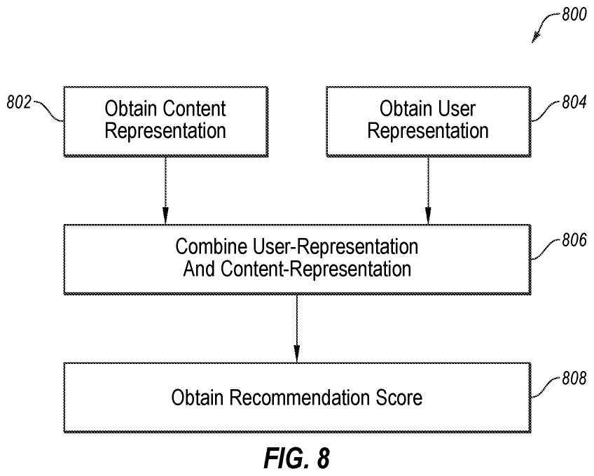

FIG. 8 is a flowchart of an example method 800 of obtaining a content recommendation, according to at least one embodiment described in the present disclosure. The method 800 may be performed by any suitable system, apparatus, or device. For example, one or more of the modules of FIG. 1A or the computing system 202 of FIG. 2 (e.g., as directed by one of the modules) may perform one or more of the operations associated with the operations 400. Although illustrated with discrete blocks, the steps and operations associated with one or more of the blocks of the operations 400 may be divided into additional blocks, combined into fewer blocks, or eliminated, depending on the particular implementation.

The method 800 may include a block 802, at which a content representation associated with a particular content item may be obtained. The particular content item may be content that may be disseminated via a social network. In some embodiments, the content representation may be an updated content representation that corresponds to the particular content item. For example, the content representation may be a particular second content representation 324 of FIG. 3 that corresponds to the particular content item.

The method 800 may include a block 804, at which a user representation associated with a particular user of the social network may be obtained. In some embodiments, the user representation may be an updated user representation that corresponds to the particular user. For example, the user representation may be a particular second user representation 348 of FIG. 3 that corresponds to the particular user.

At block 806, the user representation and the content representation may be combined. For example, in some embodiments, the user representation may include an updated user vector and the content representation may include an updated content vector. In these or other embodiments, the combining may include concatenating the user vector and the content vector.

At block 808, a recommendation score may be obtained based on the combined user representation and content representation. For example, in some embodiments, the combined user representation and content representation may be provided to a user-content classifier that may be generated and trained such as described above with respect to FIGS. 3-7. The user-content classifier may generate a recommendation score for the particular user with respect to the particular content item based on a relationship between the particular user and the particular content item determined using the classifications included therein.

In some embodiments, the particular content item may be recommended to the particular user based on the recommendation score. For example, in some embodiments, the particular content item may be recommended in response to the recommendation score satisfying a particular threshold. In these or other embodiments, the method 800 may be performed with respect to each of one or more content items and the particular user to identify respective recommendation scores with respect to each content item as related to the particular user. In these or other embodiments, one or more of the content items may be selected for recommendation to the particular user based on relative rankings of the content items based on their respective recommendation scores.

Modifications, additions, or omissions may be made to the method 800 without departing from the scope of the present disclosure. For example some of the operations of method 800 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

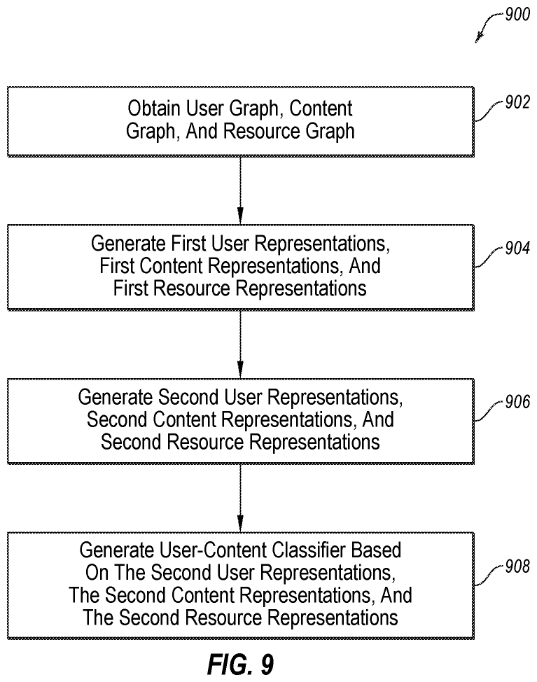

FIG. 9 is a flowchart of an example method 900 of generating a user-content classifier, according to at least one embodiment described in the present disclosure. The method 900 may be performed by any suitable system, apparatus, or device. For example, one or more of the modules of FIG. 1A or the computing system 202 of FIG. 2 (e.g., as directed by one of the modules) may perform one or more of the operations associated with the operations 400. Although illustrated with discrete blocks, the steps and operations associated with one or more of the blocks of the operations 400 may be divided into additional blocks, combined into fewer blocks, or eliminated, depending on the particular implementation.

The method 900 may include a block 902, at which a user graph, a content graph, and a resource graph may be obtained. In some embodiments, the graphs may be obtained such as described above with respect to FIGS. 1A and 1B.

At block 904, multiple first user representations that are each associated with a respective user of a social network may be obtained. Additionally, multiple first content representations that are each associated with a respective content item disseminated via the social network may be obtained. Additionally or alternatively, multiple first resource representations that are each associated with a respective external resource that may be linked to one or more of the content items may be obtained. In some embodiments, the first representations may be obtained such as described above with respect to FIG. 3.

At block 906, multiple second user representations that are each associated with a respective first user representation may be obtained. Additionally, multiple second content representations that are each associated with a respective first content representation may be obtained. Additionally or alternatively, multiple second resource representations that are each associated with a respective first resource representation may be obtained. In some embodiments, the second representations may be obtained such as described above with respect to FIGS. 3-7.

At block 908, a user-content classifier may be generated based on the second user representations, the second content representations, and the second resource representations. In these or other embodiments, the user-content classifier may be generated such as described above with respect to FIGS. 3-7.

Modifications, additions, or omissions may be made to the method 900 without departing from the scope of the present disclosure. For example some of the operations of method 900 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments. For example, in some embodiments, one or more of the operations of the method 800 may be included with the method 900

As indicated above, the embodiments described in the present disclosure may include the use of a special purpose or general purpose computer including various computer hardware or software modules, as discussed in greater detail below. Further, as indicated above, embodiments described in the present disclosure may be implemented using computer-readable media for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. This interpretation of the phrase “A or B” is still applicable even though the term “A and/or B” may be used at times to include the possibilities of “A” or “B” or “A and B.”

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
obtaining a user graph that indicates links between users of a social network;
obtaining a content graph that indicates links between the users of the social network and content items interacted with by the users via the social network;
obtaining a resource graph that indicates links between the content items and external resources included in the content items;
generating first user representations of the users of the social network;
generating first content representations of the content items;
generating first resource representations of the external resources;
generating second resource representations of the external resources based on the first content representations, the first resource representations, and the resource graph;
generating second content representations of the content items based on the first content representations, the first user representations, the content graph, and the second resource representations;
generating second user representations of the users based on the first user representations, the user graph, the first content representations, and the content graph; and
generating a user-content relation classifier of a machine learning network based on combinations of the second content representations and the second user representations, each combination including one of the second content representations and one of the second user representations.

2. The method of claim 1, further comprising obtaining, from the user-content relation classifier, a recommendation of a particular content item for a particular user of the users based on a particular second user representation associated with the particular user and based on a particular second content representation associated with the particular content item, wherein the particular second user representation and the particular second content representation are provided as inputs to the user-content relation classifier.

3. The method of claim 1, wherein generating a respective second resource representation for a respective external resource includes:
determining relevance measures between the content items and the respective external resource based on each of the first content representations and a respective first resource representation of the respective external resource, wherein each respective relevance measure is between a respective content item and the respective external resource;
generating an aggregated content representation based on the relevance measures and the first content representations; and
generating the respective second resource representation based on a combination of the aggregated content representation and the respective first resource representation.

4. The method of claim 1, wherein generating a respective second content representation for a respective content item includes:
determining relevance measures between the users and the respective content item based on each of the first user representations and a respective first content representation of the respective content item, wherein each respective relevance measure is between a respective user and the respective content item;
generating an aggregated user representation based on the relevance measures and the first user representations;
generating an intermediate content representation based on a combination of the aggregated user representation and the respective first content representation; and
generating the respective second content representation based on a combination of the intermediate content representation and one of the second resource representations.

5. The method of claim 4, further comprising generating edge representations based on the first user representations and the respective first content representation, wherein each respective edge representation is based on a respective first user representation and the respective first content representation and indicates a manner in which the user associated with the respective first user representation shared the respective content item, wherein determining the relevance measures is based on the edge representations.

6. The method of claim 1, wherein generating a respective second user representation for a respective user includes:
generating a first intermediate user representation based on the user graph, a respective first user representation of the respective user, and other first user representations that correspond to the other users;
generating a second intermediate user representation based on the content graph, the respective first user representation, and the first content representations; and
generating the respective second user representation based on the first intermediate representation and the second intermediate representation.

7. The method of claim 6, wherein:
the first intermediate user representation is further based on first relevance measures between the respective user and the other users; and
the second intermediate user representation is further based on second relevance measures between the respective user and the content items.

8. A system comprising:
one or more processors; and
one or more non-transitory computer-readable storage media configured to store instructions that, in response to being executed by the one or more processors, cause the system to perform operations, the operations comprising:
obtaining a user graph that indicates links between users of a social network;
obtaining a content graph that indicates links between the users of the social network and content items interacted with by the users via the social network;
obtaining a resource graph that indicates links between the content items and external resources included in the content items;
generating first user representations of the users of the social network;
generating first content representations of the content items;
generating first resource representations of the external resources;
generating second resource representations of the external resources based on the first content representations, the first resource representations, and the resource graph;
generating second content representations of the content items based on the first content representations, the first user representations, the content graph, and the second resource representations;
generating second user representations of the users based on the first user representations, the user graph, the first content representations, and the content graph; and
generating a user-content relation classifier of a machine learning network based on combinations of the second content representations and the second user representations, each combination including one of the second content representations and one of the second user representations.

9. The system of claim 8, the operations further comprising obtaining, from the user-content relation classifier, a recommendation of a particular content item for a particular user of the users based on a particular second user representation associated with the particular user and based on a particular second content representation associated with the particular content item, wherein the particular second user representation and the particular second content representation are provided as inputs to the user-content relation classifier.

10. The system of claim 8, wherein generating a respective second resource representation for a respective external resource includes:
determining relevance measures between the content items and the respective external resource based on each of the first content representations and a respective first resource representation of the respective external resource, wherein each respective relevance measure is between a respective content item and the respective external resource;
generating an aggregated content representation based on the relevance measures and the first content representations; and
generating the respective second resource representation based on a combination of the aggregated content representation and the respective first resource representation.

11. The system of claim 8, wherein generating a respective second content representation for a respective content item includes:
determining relevance measures between the users and the respective content item based on each of the first user representations and a respective first content representation of the respective content item, wherein each respective relevance measure is between a respective user and the respective content item;
generating an aggregated user representation based on the relevance measures and the first user representations;
generating an intermediate content representation based on a combination of the aggregated user representation and the respective first content representation; and
generating the respective second content representation based on a combination of the intermediate content representation and one of the second resource representations.

12. The system of claim 11, the operations further comprising generating edge representations based on the first user representations and the respective first content representation, wherein each respective edge representation is based on a respective first user representation and the respective first content representation and indicates a manner in which the user associated with the respective first user representation shared the respective content item, wherein determining the relevance measures is based on the edge representations.

13. The system of claim 8, wherein generating a respective second user representation for a respective user includes:
generating a first intermediate user representation based on the user graph, a respective first user representation of the respective user, and other first user representations that correspond to the other users;
generating a second intermediate user representation based on the content graph, the respective first user representation, and the first content representations; and
generating the respective second user representation based on the first intermediate representation and the second intermediate representation.

14. The system of claim 13, wherein:
the first intermediate user representation is further based on first relevance measures between the respective user and the other users; and
the second intermediate user representation is further based on second relevance measures between the respective user and the content items.

15. One or more non-transitory computer-readable storage media configured to store instructions that, in response to being executed, cause a system to perform operations, the operations comprising:
obtaining a user graph that indicates links between users of a social network;
obtaining a content graph that indicates links between the users of the social network and content items interacted with by the users via the social network;
obtaining a resource graph that indicates links between the content items and external resources included in the content items;
generating first user representations of the users of the social network;
generating first content representations of the content items;
generating first resource representations of the external resources;
generating second resource representations of the external resources based on the first content representations, the first resource representations, and the resource graph;
generating second content representations of the content items based on the first content representations, the first user representations, the content graph, and the second resource representations;
generating second user representations of the users based on the first user representations, the user graph, the first content representations, and the content graph; and
generating a user-content relation classifier of a machine learning network based on combinations of the second content representations and the second user representations, each combination including one of the second content representations and one of the second user representations.

16. The one or more non-transitory computer-readable storage media of claim 15, the operations further comprising obtaining, from the user-content relation classifier, a recommendation of a particular content item for a particular user of the users based on a particular second user representation associated with the particular user and based on a particular second content representation associated with the particular content item, wherein the particular second user representation and the particular second content representation are provided as inputs to the user-content relation classifier.

17. The one or more non-transitory computer-readable storage media of claim 15, wherein generating a respective second resource representation for a respective external resource includes:
determining relevance measures between the content items and the respective external resource based on each of the first content representations and a respective first resource representation of the respective external resource, wherein each respective relevance measure is between a respective content item and the respective external resource;
generating an aggregated content representation based on the relevance measures and the first content representations; and
generating the respective second resource representation based on a combination of the aggregated content representation and the respective first resource representation.

18. The one or more non-transitory computer-readable storage media of claim 15, wherein generating a respective second content representation for a respective content item includes:
determining relevance measures between the users and the respective content item based on each of the first user representations and a respective first content representation of the respective content item, wherein each respective relevance measure is between a respective user and the respective content item;
generating an aggregated user representation based on the relevance measures and the first user representations;
generating an intermediate content representation based on a combination of the aggregated user representation and the respective first content representation; and
generating the respective second content representation based on a combination of the intermediate content representation and one of the second resource representations.

19. The one or more non-transitory computer-readable storage media of claim 18, the operations further comprising generating edge representations based on the first user representations and the respective first content representation, wherein each respective edge representation is based on a respective first user representation and the respective first content representation and indicates a manner in which the user associated with the respective first user representation shared the respective content item, wherein determining the relevance measures is based on the edge representations.

20. The one or more non-transitory computer-readable storage media of claim 15, wherein generating a respective second user representation for a respective user includes:
generating a first intermediate user representation based on the user graph, a respective first user representation of the respective user, and other first user representations that correspond to the other users;
generating a second intermediate user representation based on the content graph, the respective first user representation, and the first content representations; and
generating the respective second user representation based on the first intermediate representation and the second intermediate representation.
